(19) United States
(12) Patent Application Publication
(10) Pub. No.: US 2015/0016242 A1
(43) Pub. Date: Jan. 15, 2015

(54) Method and Apparatus for Optimized LFA Computations by Pruning Neighbor Shortest Path Trees

(71) Applicant: Telefonaktiebolaget L M Ericsson (publ), Stockholm (SE)

(72) Inventors: Lars Ernström, Palo Alto, CA (US); Alfred C. Lindem, III, Cary, NC (US); Pramodh D'Souza, San Jose, CA (US); Evgeny Tantsura, Palo Alto, CA (US)

(21) Appl. No.: 13/941,316

(22) Filed: Jul. 12, 2013

(51) Int. Cl. H04L 12/733; H04L 12/703

(52) U.S. Cl. CPC H04L 45/122; H04L 45/28
USPC 370/218

(57) ABSTRACT

A method is implemented by a network element for determining a next hop of a backup path for a fast reroute process to be utilized in response to a network event invalidating a primary path to a destination node. The method reduces computational requirements of the network element by reducing a number of paths to be evaluated without affecting selection of the backup path. The method selects a neighbor node P of a source node S to calculate a shortest path tree (SPT) for P for use in identifying backup paths for S. The SPT is calculated for P, pruning paths from the SPT that traverse S or that fail an LFA condition. P is selected for the next hop of the backup path for a destination node X where the SPT of P provides an LFA path from S to the destination node X.

### FIELD OF THE INVENTION

The embodiments of the invention relate to the field of network routing. Specifically, the embodiments relate to a method and system for efficiently calculating backup paths to be utilized for quickly rerouting data traffic in response to a failure of a primary path, by switching to the predetermined loop free alternative (LFA) backup path.

### BACKGROUND

Internet Protocol (IP) traffic can be routed across the Internet by using discovery and routing protocols that are executed by the nodes of the Internet such that they can determine optimal and loop free routes from any data traffic source to any data traffic destination using topology information exchanged between the nodes. Each node in the network utilizes the topology ascertained through the discovery protocols to construct forwarding tables that are consistent across the network. The process of arriving at these routes and forwarding tables can be called ‘convergence.’ The routes and forwarding tables are recalculated when there is a change in network topology. However, re-calculating these routes and tables can take time (i.e., long convergence time) during which some traffic may be blocked or lost.

IP and Multi-Protocol Label Switching (MPLS) Fast Reroute (FRR) technologies address the problem with the long convergence of routing protocols by providing backup paths, which are used when network failures occur. These technologies are important due to the increased use of IP transport for real time services such as video, voice and television and the increasing number of web services which all are expected to work without disruption.

The standard approach used in existing technologies, such as open shortest path first (OSPF)/intermediate system-intermediate system (ISIS)/label distribution protocol (LDP) loop free alternative (LFA), maximally redundant trees (MRT), border gateway protocol (BGP) fast reroute (FRR), is to gather network information using a routing/signaling protocol and based on that information compute the backup paths necessary to prepare for failures of adjacent links or nodes, and then to pre-provision the forwarding plane with those back-up paths. The forwarding plane is then able to react on a failure event and switch from a primary path to a back-up path without waiting for the routing protocol to gather updated network information and converge.

### SUMMARY

A method is implemented by a network element for determining a next hop of a backup path for a fast reroute process to be utilized in response to a network event invalidating a primary path to a destination node. The method reduces computational requirements of the network element by reducing a number of paths to be evaluated without affecting selection of the backup path. The method selects a neighbor node P of a source node S to calculate a shortest path tree (SPT) for the neighbor node P for use in identifying backup paths for source node S. The SPT is calculated for the neighbor node P, pruning paths from the SPT that traverse source node S or that fail an LFA condition. The neighbor node P is selected for the next hop of the backup path for a destination node X where the SPT of the neighbor node P provides an LFA path from the source node S to the destination node X.

A network element is presented that is configured to implement a method to determine a next hop of a backup path for a fast reroute process to be utilized in response to a network event invalidating a primary path to a destination node. The method implemented by the network element reduces computational requirements of the network element by reducing a number of loop paths to be evaluated without affecting selection of the backup path. The network element includes at least one forwarding element and a route processor. The forward element is configured to forward data traffic along a primary path until the network event and to forward the data traffic along the backup LFA path after the network event. The route processor is coupled to the at least one forwarding element. The route processor is configured to execute a primary path calculation module and a backup path calculation module. The backup path calculation module is configured to select a neighbor node P of a source node S to calculate a shortest path tree (SPT) for the neighbor node P for use in identifying backup paths for source node S, to calculate the SPT for the neighbor node P, pruning paths from the SPT that traverse source node S or that fail an LFA condition, and to select the neighbor node P for the next hop of the backup path for a destination node X where the SPT of the neighbor node P provides an LFA path from the source node S to the destination node X.

A controller of a split-architecture network is configured to implement a method to determine a next hop of a backup path for a fast reroute process to be utilized in response to a network event invalidating a primary path from a network element that is a source node S to a destination node in the network. The controller implements the method to reduce computational requirements of the controller by reducing a number of paths to be evaluated without affecting selection of the backup path. The controller includes a flow controller to configure the network event to forward data traffic along a primary path before the network event and along the backup LFA path after the network event and a processor coupled to flow controller, where the processor is configured to execute a primary path calculation module and a backup path calculation module. The backup path calculation module is configured to select a neighbor node P of the source node S to calculate a shortest path tree (SPT) for the neighbor node P for use in identifying backup paths for source node S, to calculate the SPT for the neighbor node P, pruning paths from the SPT that traverse source node S or that fail an LFA condition, and to select the neighbor node P for the next hop of the backup path for a destination node X where the SPT of the neighbor node P has the least hops to the destination node X.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a flowchart of one embodiment of a process for optimized loop free alternative (LFA) backup path calculation.

FIG. 2 is a diagram of one embodiment of an example topology and network element configuration demonstrating an LFA condition.

FIG. 3 is a diagram of one embodiment of an example topology and network element configuration demonstrating pruning for an SPT of a neighbor node.

FIG. 4 is a diagram of one example embodiment of a first optimization for backup LFA path calculation.

FIG. 5 is a diagram of one example embodiment of a second optimization for backup LFA path calculation.

FIG. 6 is a flowchart of one embodiment of a process for pruned SPT calculation.

FIG. 7 is a diagram of one embodiment of a network element implementing the optimized backup LFA path calculation process.

FIG. 8 is a diagram of one embodiment of a split-architecture implementation of the process.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. In other instances, control structures, gate level circuits and full software instruction sequences have not been shown in detail in order not to obscure the invention. Those of ordinary skill in the art, with the included descriptions, will be able to implement appropriate functionality without undue experimentation.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

To facilitate understanding of the embodiments, dashed lines have been used in the figures to signify the optional nature of certain items (e.g., features not supported by a given embodiment of the invention; features supported by a given embodiment, but used in some situations and not in others).

The techniques shown in the figures can be implemented using code and data stored and executed on one or more electronic devices. An electronic device (e.g., an end station, a network device) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals—such as carrier waves, infrared signals). In addition, such electronic devices includes hardware such as a set of one or more processors coupled to one or more other components, such as one or more non-transitory machine-readable media (to store code and/or data), user input/output devices (e.g., a keyboard, a touchscreen, and/or a display), and network connections (to transmit code and/or data using propagating signals). A ‘set,’ as used herein, refers to any positive whole number of items. The coupling of the set of processors and other components is typically through one or more busses and bridges (also termed as bus controllers). Thus, a non-transitory machine-readable medium of a given electronic device typically stores instructions for execution on one or more processors of that electronic device. One or more parts of an embodiment of the invention may be implemented using different combinations of software, firmware, and/or hardware.

As used herein, a network device (e.g., a router, switch, bridge) is a piece of networking equipment, including hardware and software that communicatively interconnects other equipment on the network (e.g., other network devices, end stations). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). Subscriber end stations (e.g., servers, workstations, laptops, netbooks, palm tops, mobile phones, smartphones, multimedia phones, Voice Over Internet Protocol (VOIP) phones, user equipment, terminals, portable media players, GPS units, gaming systems, set-top boxes) access content/services provided over the Internet and/or content/services provided on virtual private networks (VPNs) overlaid on (e.g., tunneled through) the Internet. The content and/or services are typically provided by one or more end stations (e.g., server end stations) belonging to a service or content provider or end stations participating in a peer to peer service, and may include, for example, public webpages (e.g., free content, store fronts, search services), private webpages (e.g., username/password accessed webpages providing email services), and/or corporate networks over VPNs. Typically, subscriber end stations are coupled (e.g., through customer premise equipment coupled to an access network (wired or wirelessly)) to edge network devices, which are coupled (e.g., through one or more core network devices) to other edge network devices, which are coupled to other end stations (e.g., server end stations).

The embodiments of the invention described herein below provide a method and apparatus for use in connection with fast reroute for Internet Protocol (IP) and multi-protocol label switching (MPLS), media access control (MAC) routes or other addressing scheme used for communication in a data network. The method and apparatus support a control plane that keeps forwarding paths or next hops for both primary and back-up paths to all destination nodes. In a network consisting of a large number of routers it is of importance that efficient algorithms are applied in the network elements for the computation of the backup paths. Inefficient algorithms will limit the scale of the area of a protection domain, i.e. they limit the number of network elements that can participate in a routing domain where IP Fast Reroute (IPFRR) IPFRR protection is deployed. Algorithms for calculating the backup paths ensure that the back path is a loop free alternative (LFA) to a primary path. The calculation of backup LFA paths does increase the amount of computation, compared to the standard shortest path computation, by a factor proportional to the number of neighbor routers in the domain. For calculating remote backup LFA path algorithms there is a further increase in the amount of computation by a factor, in the worst case, proportional to the total number of network elements in the protection domain. The methods and apparatus described herein below improve the efficiency of computation of backup LFA paths.

Fast rerouting (FRR) technologies include the calculation of Loop Free Alternates (LFA) backup paths and remote backup LFA paths, sometimes simply referred to as LFA and remote LFA, which are technologies used to provide Internet Protocol Fast rerouting (IPFRR) based on Interior Gateway Protocols (IGPs) such as open shortest path first (OSPF) and intermediate system—intermediate system (ISIS) protocols. An IGP running within a network element builds a database (e.g., a routing information base (RIB)), which tracks all links within the applicable network area. The process for determining backup LFA paths computes loop free alternate paths using the IGP database. Border gateway protocol (BGP) diverse path, BGP best external, and BGP add path are BGP technologies, which gives BGP routers the capability to distribute and learn multiple alternates for a single prefix and the ability to realize IPFRR. Examples may be discussed using specific routing and FRR technologies, however, one skilled in the art would understand that the principles, steps and structures of these examples are applicable to the other technologies.

The algorithm for computing backup LFA paths is a method where a network element implementing FRR computes shortest path trees (SPTs), not only with itself as root for the primary paths, but also computes a separate SPT for each neighbor network element, with the neighbor as the root of the respective SPT. These neighbor SPTs are used to determine the loop free backup paths. Given a source node S, for a given destination X, a neighbor P can be used as a next hop of a backup LFA path if a loop-free condition is satisfied.

However the disadvantages of the prior art include that the computation of backup LFA paths is inefficient, because the number of neighbors increases the amount of calculation (i.e., the generation of SPTs for each neighbor) proportionately. The embodiments of the invention overcome these disadvantages by using a method to compute the SPT for each neighbor node, optionally including remote LFA candidate nodes. The computed SPT are pruned when a node is reached that does not represent a loop free alternative path. All further computations to calculate the SPT from the node that fails the LFA condition or that requires traversal of the source node are curtailed. This reduces the size and computations required for computing the SPT for each neighbor node without altering the resulting backup LFA paths and next hops that are selected. In other words, the full SPT for each neighbor node does not have to be computed, instead a ‘pruned’ tree is calculated that excludes those sections of the tree that do not meet loop free conditions or that must traverse the source node S.

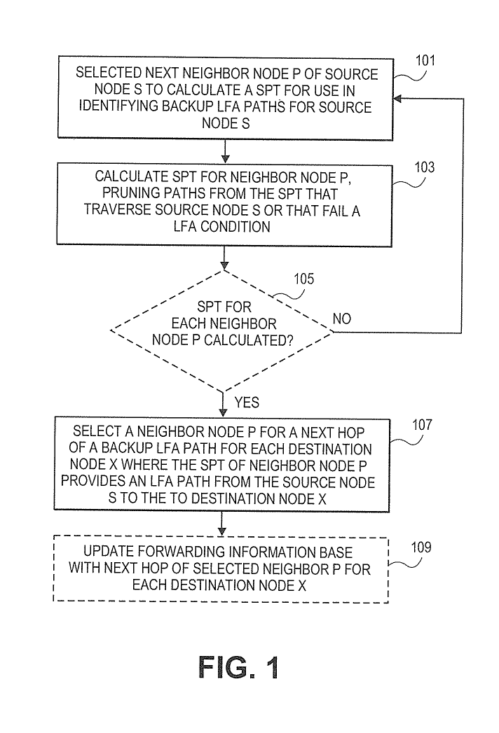

FIG. 1 is a flowchart of one embodiment of a process for optimized loop free alternative (LFA) backup path calculation. In one embodiment, the process is initiated any time after the primary paths for the network element have been calculated. The SPT of the network element is calculated using the routing information base of the network element. The primary paths are then programmed into the forwarding information base or similar components of the forwarding elements of the network element. This process of calculating the primary paths can be done at the start-up of the network element and in response to any changes in the network topology or similar network events. Similarly, the backup LFA path computations can be determined at start-up after the primary paths are calculated and can be updated each time there is a network event such as a change in the topology of the network.

The backup LFA path calculation process determines SPTs for each neighboring node, optionally including remote nodes with which a tunnel can be established as part of remote LFA process. The tunnel provides a neighbor relationship between a source node S and a neighbor node P. Remote backup LFA paths are composed of the tunnel segment and a second segment that is a shortest path from the neighbor node P to the destination node D. The examples provided herein are primarily related to the application of the process to immediate neighbor nodes. However, one skilled in the art would understand that the principles and structures described herein in relation to this example are also applicable to remote LFA applications and similar alternative implementations.

In one embodiment, the process begins by selecting one of the plurality of neighbors of the source node to calculate the SPT of that neighbor (Block 101). The SPTs of the neighbor nodes can be calculated in any order either serially or in parallel. The calculation of the SPTs for each neighbor node is independent of the calculation of the other neighbors. Once all of the SPTs are calculated they can be used to determine a backup LFA path to each destination node X in the network. The backup LFA path is selected from all of the available paths to the destination node X across all of the SPTs of the neighbor nodes such that the shortest path (optionally meeting protection and shared risk link group (SRLG) criteria) is selected as the backup LFA path that is not identical to the primary path.

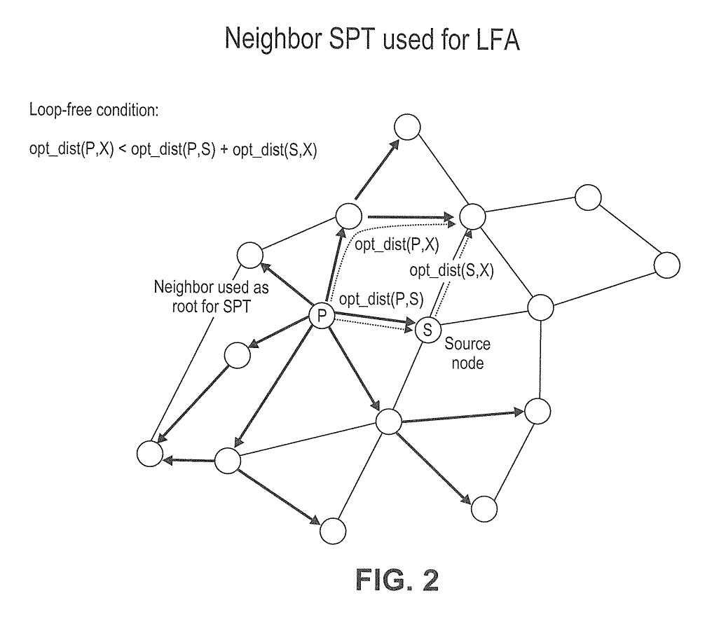

An SPT is calculated for the selected neighbor node P (Block 103). During the calculation of the SPT all paths that traverse the source node S or that fail an LFA condition are pruned from the tree. This pruning reduces the number of calculations required in the calculation of the SPT and will save computation in the comparison or traversal of the pruned paths as well as save storage space that would have been utilized for storing larger SPTs. Any SPT generation algorithm can be utilized, such as Dijkstra's algorithm or similar shortest path algorithms, where the shortest path algorithm is modified to avoid further computations of downstream nodes when a node suitable for pruning is detected. The scenarios for pruning the SPT are discussed further herein below with regard to FIGS. 2-5.

As each SPT is calculated, a check can be made whether all the SPTs of all of the neighbor nodes have been calculated (Block 105). If all of the SPTs of all of the neighbor nodes have not been calculated, then the process continues to the calculation of the next SPT for the next neighbor node (Block 101). If all of the SPTs of all of the neighbor nodes have been calculated, then for each destination node X in the network a backup LFA path is chosen (Block 107). The entire backup LFA path can be stored or the next hop neighbor node P can be utilized to update the forwarding information base to program forwarding for data traffic destined for destination node X (Block 109).

FIG. 2 is a diagram of one embodiment of an example topology and network element configuration demonstrating a scenario where a failed LFA condition causes pruning. The diagram shows and example network configuration with each node in the network illustrated with a circle and each connection between the nodes of the network being illustrated with a connecting line. Each connection is assumed in this example to have an equal distance, however, one skilled in the art would understand that the process can also apply to scenarios where each link is not equidistant. The original source node is labeled ‘S,’ that is the node for which the primary paths have been calculated and that backup LFA paths are being calculated. The neighbor node ‘P’ is being evaluated in this scenario with regard to finding the backup LFA path to a destination node ‘X.’ These labels are used in examples through the description. An optimal distance function is labeled ‘opt_dist(x, y)’ with ‘x,’ and ‘y’ being arguments to the function, where x is the starting node and y is the destination node and where the function determines the minimum number of hops from the starting node to the destination node for a given network.

In this example the SPT for the neighbor node P is shown with the bold arrow lines radiating out from neighbor node P. An example loop free condition can be defined such as opt_dist(P,X)<opt_dist(P, S)+opt_dist(S,X), measured in terms of the aggregate link cost along the LFA path. In the case where a selected path from the neighbor node P to the destination node X is shorter (using the applicable metric) than the distance from neighbor node P to destination node X on a path that traverses the source node, then the selected path is known to be a LFA path eligible to be selected as the backup LFA path. If the selected path had a greater distance then the destination node can be identified as a pruning point for the SPT.

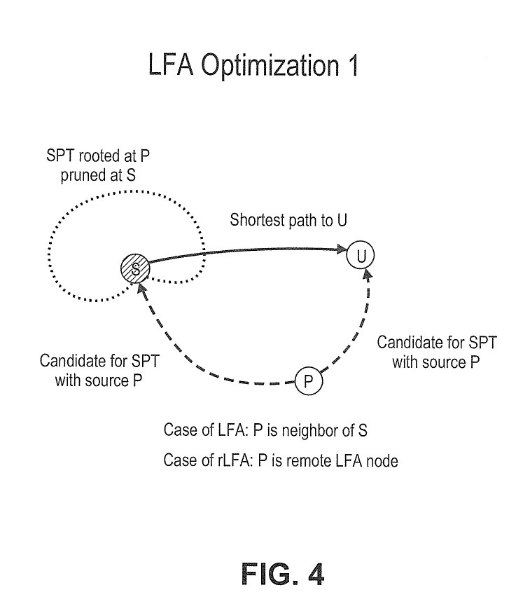

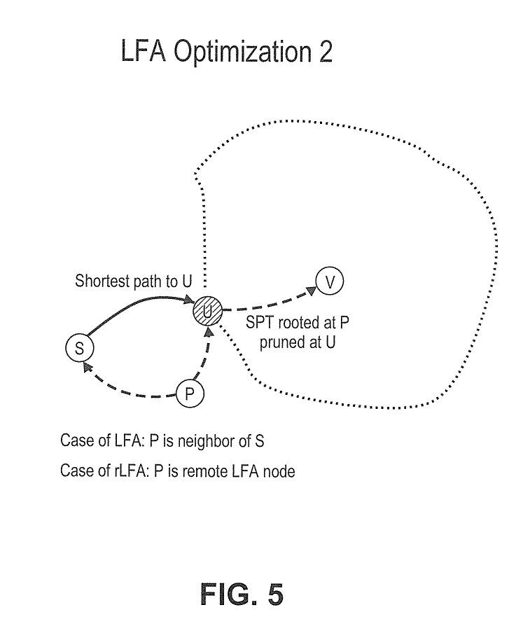

The SPT can also be pruned under other conditions than the LFA condition. The SPT can be pruned where paths that traverse the source node are detected. In other words, the source node S can be a pruning point for each SPT generated for the neighbor nodes. Each of these separate pruning optimizations is illustrated below in FIGS. 4 and 5.

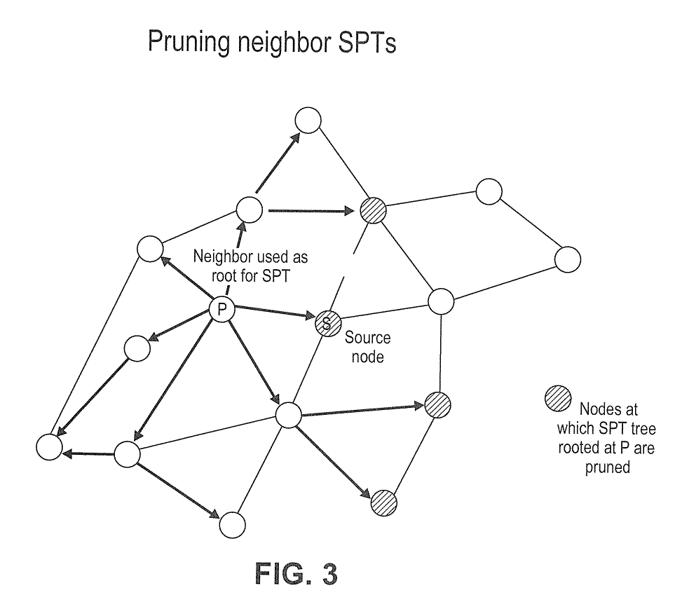

FIG. 3 is a diagram of one embodiment of an example topology and network element configuration demonstrating pruning for an SPT of a neighbor node. With the LFA condition and source node pruning applied the SPT may not reach each of the nodes of the network. The nodes at which pruning would occur in this example are shaded. The neighbor node P can be considered a candidate for use as a next hop for backup LFA paths for each of the nodes in the pruned SPT of the neighbor node P. However, nodes in the pruned areas of the network will not be reachable through the neighbor node P, because traffic to the nodes in these areas will loop back to the source S. In this example, the SPT for neighbor node P omits three nodes for the example network. These nodes would be reachable via other neighbor nodes and this will not result in any deviation in the selected backup LFA paths for the source node S, in comparison with the use of full SPT for each neighbor node. The proof of the equivalent back LFA path selection is described herein below.

FIG. 4 is a diagram of one example embodiment of a first optimization for backup LFA path calculation. In the first optimization, as discussed above, an SPT for a neighbor node P is pruned at the source node S. In the illustration, the dotted area designates the portion of the network that has been pruned with regard to all paths of the SPT for a neighbor node P that traverse the source nodes S. The dashed lines are candidate SPT paths from neighbor P to the source S and to another node U. The shortest path to U from S is shown (as a solid arrow) and it falls within the pruned section of the SPT of neighbor P. This optimization can be performed where the neighbor node is an immediate neighbor (i.e., a direct communication link) or where a tunnel exists, or can be setup, between the source node S and neighbor node P (sometimes referred to as a ‘remote LFA’).

FIG. 5 is a diagram of one example embodiment of a second optimization for backup LFA path calculation. In the second optimization, as discussed above, an SPT for a neighbor node P can be pruned at another node U where the LFA condition fails, where node U can be any node in the network. In the illustration, the dotted area designates the portion of the network that has been pruned with regard to all paths that traverse the nodes U that fails the LFA condition. The dashed lines are candidate SPT paths from neighbor P to the source S and to another node U. The shortest path to U from S is shown (as a solid arrow). An additional dashed line to another node V is shown and it falls within the pruned section of the SPT of neighbor P. This optimization can be performed where the neighbor node is an immediate neighbor (i.e., a direct communication link) or where a tunnel exists, or can be setup, between the source node S and neighbor node P (i.e., remote LFA).

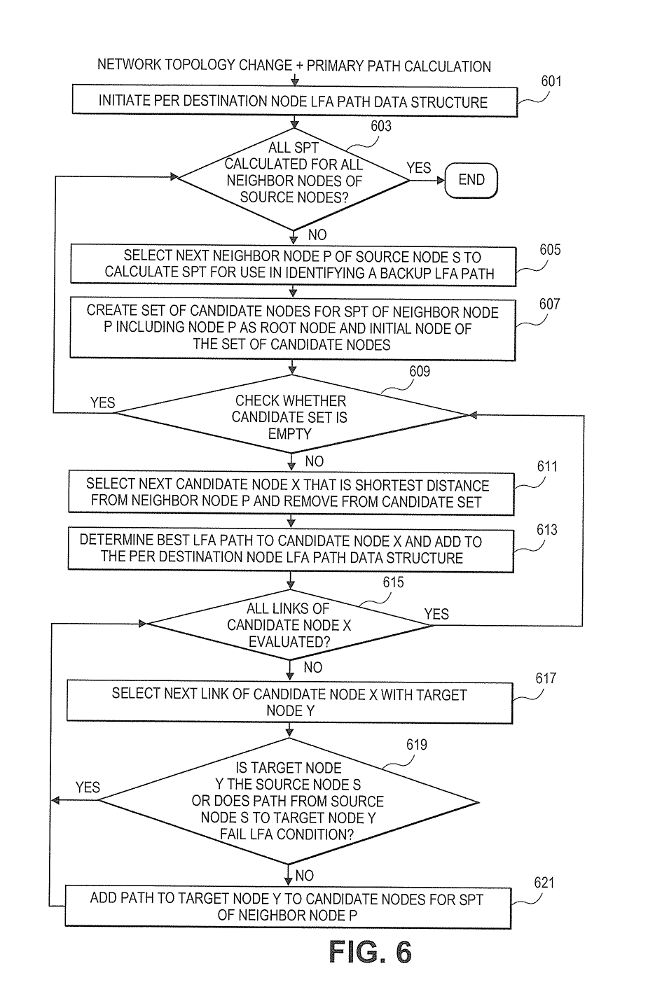

FIG. 6 is a flowchart of one embodiment of a process for pruned SPT calculation. This process details the identification of backup LFA paths during the calculation of the SPT for each neighbor node P (remote or local) of a source node S. The process can be initiated in response to a change in network topology and will take place after the primary path to each destination node in the network has been calculated. The process can initiate a per destination node LFA path data structure to store each backup LFA path as it is determined (Block 601). The data structure can have any format, size or characteristics suitable for storing the set of backup LFA paths. In some embodiments, the routing information base can store this information. The process iterates through the neighbor nodes of the source node S and begins by checking whether all the SPT have been calculated for all the neighbor nodes of the source node S on each iteration (Block 603). If all of the SPT have been calculated then the backup LFA paths have been identified and placed in the per destination node LFA path data structure. The process can then end.

If all of the SPT of the neighbor nodes have not yet been calculated, then the process continues by selecting a next neighbor node P of the source node S for which an SPT has not yet been calculated (Block 605). The set of neighbors is known through discovery protocols establishing adjacency between nodes in a network such as intermediate-system to intermediate-system (IS-IS) and similar protocols. The SPT will be utilized to identify a set of backup LFA paths for the source node S to each possible destination in the network. For each neighbor node P a candidate node set is created (Block 607). Initially, the candidate node set includes only the neighbor node P, which is the starting point for constructing the SPT for the neighbor node P. The candidate node set is used to track which nodes have yet to be evaluated in a progression outward from the neighbor node P. This is an iterative process where the process completes when the candidate set has been exhausted (Block 609).

The process continues by selecting a next candidate node X for which to identify a shortest path from the neighbor node P to add to the SPT being formed (Block 611). As a candidate node X is evaluated it is removed from the candidate node set. The construction of the SPT can be a modification of Dijkstra's algorithm or similar algorithm for forming SPTs. This process can traverse the topology of the network to find paths to the candidate node X. Specifically, the best LFA path to the candidate node X is determined and added to the per destination node LFA path data structure (Block 613). A special case exists for where the candidate node X is the initial neighbor node P. In this case additional criteria can be applied such as whether node protection is met and similar criteria such as for example SRLG.

After the best LFA path is determined for the candidate node X, then the adjacent nodes of candidate node X are evaluated to determine whether they are also reachable as possible backup LFA path destinations. This process iterates through each link of candidate node x until all have been examined (Block 615).

As each linked target node Y of the candidate node X is selected (Block 617) and traversed a check can be made whether the target node Y is a source node S (Block 619). Paths that traverse the source node S can be selected for pruning from the SPT being formed by not adding them to the candidate node set and continuing to the next adjacency or link (Block 615). Thus, the SPT algorithm is modified to curtail further traversal of the network past the source node thereby pruning any portion of the SPT that is connected to the source node S.

A check is also made at each target node Y traversed whether the target node Y meets the LFA condition (Block 619). In one embodiment, the LFA condition s opt_dist(P, Y)<opt_dist(P, S)+opt_dist(S, Y) is utilized to detect nodes for pruning. If the LFA condition for the target node Y is not failed and the target node Y is not the source node S, then the target node Y can be added to the candidate node set for the SPT of the neighbor node P (Block 621). If the target node Y is already in the SPT of P then Y must not be added to the candidate set.

The process continues to determine all remaining paths to each candidate node X in the candidate node set and selects the shortest path found to X to be added to the SPT (Block 613). This process varies depending on the SPT algorithm utilized, but in each case the process involves identifying and pruning the tree at the source node S and at nodes that fail the LFA condition, thereby curtailing further traversal of possible paths beyond these pruning points in the topology of the given network.

As discussed above, once the SPT for a neighbor node P has been completed, a check can be made whether all of the possible neighbor nodes (local or remote depending on the setting and network configuration) have had an SPT calculated according to this process (Block 603). If all SPT for the possible next hop nodes have not been calculated, then the process selects the next neighbor node P to calculate another SPT with the neighbor node P as the root according to this process (Block 605).

Once all of the neighbor node SPTs have been calculated according to this pruning SPT calculation process, the process will have selected the neighbor P for each destination node X having the preferred backup LFA path for the source node S, which will be stored in the per destination node LFA path data structure. For example the shortest backup LFA path or best meeting the protection and SRLG criteria may be preferred. This information can then be utilized to program the forwarding information base of a network element to implement the FRR with the selected backup LFA paths.

In some embodiments, this process can be expanded to support node protection and application to shared risk ling groups (SRLG). With node protection, an additional condition is placed on the identification of paths that are acceptable for including in the SPT. Specifically, particular nodes in the network can be identified to be excluded from any backup LFA path. In such cases, an additional check is made to exclude such path including these nodes. With SRLG a set of links is identified with correlated characteristics such that the members of a group are likely to fail together (e.g., where all of the links are connected to a single line card at one end). Similar to node protection, an additional check can be made to exclude potential backup paths from SPTs where links in the potential backup path are in in an SRLG with links of the primary path. In some embodiments, selection of the LFA path is conditioned based on preferences for nodes traversed by the LFA path, where the LFA path provides protection in case of failure of nodes traversed by the primary path can be preferred or administrative preference or disinclination of specific nodes can be used in the path selection. Similarly, in some embodiments, selection of the LFA path is conditioned based on preferences for links traversed by the LFA path, where the LFA path provides protection in case of failure of links traversed by the primary path can be preferred, or administrative preference or disinclination of specific links can be used in the path selection.

Proof Validating Method

As discussed above, this process identifies the same set of backup LFA paths that using full un-pruned SPTs for the neighbor nodes would identify. To prove this claim, consider:

S, the source node for LFA computation;

P, a neighbor of S (local or remote);

T, the tree rooted at P resulting from performing the shortest path algorithm subject to pruning as described above.

Given a shortest path P->D1->D2-> . . . ->Dn->X (where D1, D2, Dn are nodes in a given network leading to node X) satisfying the loop-free condition for the source S, i.e., opt_dist(P,X)<opt_dist(P,S)+opt_dist(S,X), it is required that the path is in the tree T. Proving by means of contradiction, assume that the path is not in T. Then one of the intermediate nodes, say Di, must either be equal to S or does not satisfy the loop free condition. Hence, opt_dist(P,Di)≧opt_dist(P,S)+opt_dist(S,Di). Note, in case Di=S this is a trivial fact. Now it follows that, opt_dist(P,X)=opt_dist(P,Di)+opt_dist(Di,X)≧opt_dist(P,S)+opt_dist(S,Di)+opt_dist(Di,X)≧opt_dist(P,S)+opt_dist(S,X), i.e., the path to X is not loop-free. This is a contradiction and we can conclude that the assumption that the path P->D1->D2-> . . . ->Dn->X is not in the tree T is false. This proves the pruning process will generate the same set of paths, i.e., the same tree T.

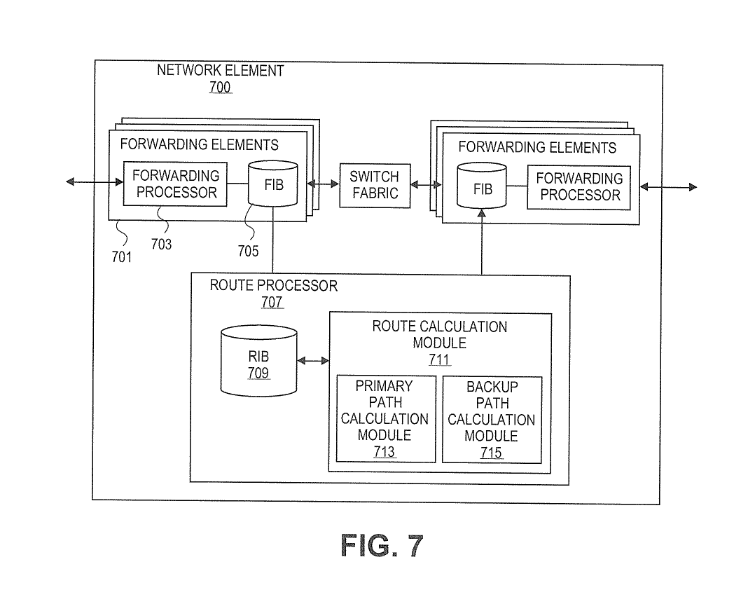

FIG. 7 is a diagram of one embodiment of a network element implementing the optimized backup LFA path calculation process. The network element 700 is provided by way of example, rather than limitation. One skilled in the art would understand that other network elements with differing configuration can implement the process described herein. In the example embodiment, the network element 700 includes a network processor 707 and a set of forwarding elements 701. The forwarding elements can be connected by an interconnect such as a switch fabric or similar interconnect allowing transfer of the data packets from one forwarding element to another. Similarly, the network processor 707 can be connected to each of the forwarding elements 701 through the same or a different set of interconnects such that the network processor can exchange data and configure the forwarding elements 701.

In one embodiment, the forwarding elements 701 can be line cards or similar components of a network element. The network element 700 can include any number of forwarding elements 701. The forwarding elements 701 can receive and forward data traffic over any number of communication links or ports. The forwarding element 701 can include a forwarding processor that processes each inbound and outbound data packet to identify how to forward the data packet toward its destination by identifying a next hop for the data packet using information stored in the forwarding information base 705. The forwarding element 701 matches the destination address and other data of the data packets with the information in the forwarding information base 705 to identify the next hop for the data packet. The forwarding processor 701 then forwards the data packet over the corresponding port or communication link or sends the data packet to another forwarding element 701 over the switch fabric that is attached to the next hop port or communication link.

In one embodiment, the route processor 707 can manage the programming and of the forwarding information base 705 using the route information base 709. The route processor 707 can manage other control plane functions of the network element 700 as well. The route information base 709 contains information regarding the topology of the network in which the network element 700 resides. The route information base 709 can be updated and maintained using any type of discovery protocol or similar control plane protocol.

In one embodiment, the route processor 707 also performs a primary path calculation module 713 that processes the information of the route information base 709 to identify the primary and back paths in support of FRR or similar protection schemes. The primary path calculation module 713 can execute a shortest path tree calculation algorithm or similar algorithm to determine a path to each of the nodes in the network. This SPT is utilized to program the next hops for each destination node in the forwarding information base 705 of the forwarding elements 701. Similarly, the backup path calculation module 715 implements the backup path identification process described herein above using an efficient SPT pruning process to calculate pruned SPTs for all neighboring nodes (i.e., LFA or rLFA), such that next hops for the backup LFA paths for all nodes in the network can be programmed into the forwarding information base 705 of the forwarding elements 701.

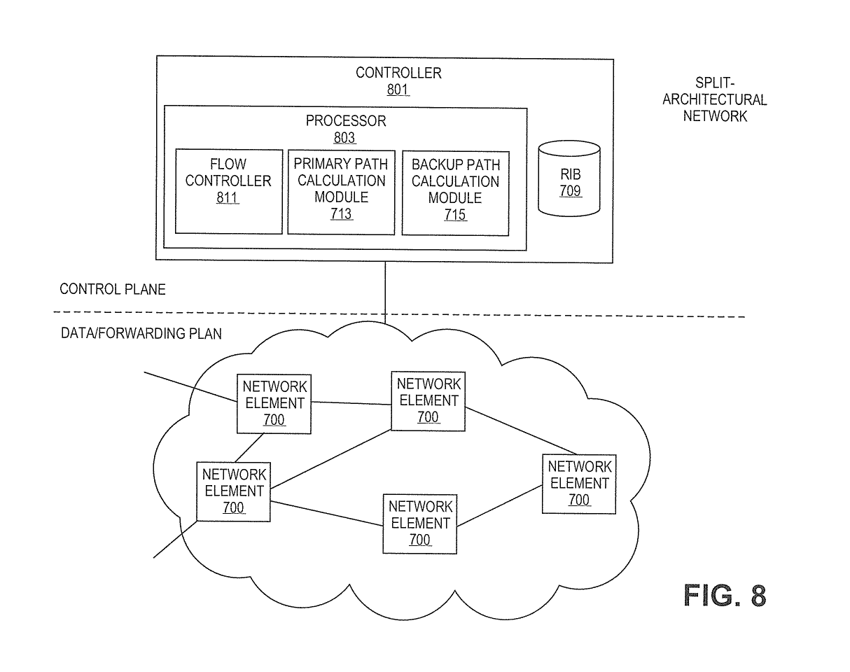

FIG. 8 is a diagram of one embodiment of a split-architecture implementation of the process. In one embodiment, the process is implemented by a controller 801 in a split-architecture, rather than at the network element 700. The controller 801 manages the control plane functionality of the network, while the network elements 700 implement the data/forwarding plane aspects of the network. Thus, the network elements 700 include the forwarding elements and forwarding information base as described above. However, the control plane functions have been removed to a remote controller 801 that can be at any location relative to the network in which the network elements 700 are situated such that the controller is in communication with each of the network elements 700.

The controller 801 can include a processor to execute the primary path calculation module 713 and the backup path calculation module 715. These functions can be implemented by a single processor 803 or a set of processors distributed over any number of devices implementing the controller 801. For sake of clarity an example with a single device and processor is described. The path calculation modules can utilize the route information base 709 that is also maintained locally or at a location in communication with the processor 803.

A flow controller 811 can implement any flow control protocol to enable the controller to communicate and configure the network elements 700 in the network, including the configuration of primary and backup paths. In one example embodiment, the flow controller 811 can communicate and configured the flow control elements of the network elements 700 using the OpenFlow protocol. One skilled in the art would understand that any similar flow control protocol can be utilized that enables the controller to configure the network elements and control the data plane of the network.

It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method implemented by a network element for determining a next hop of a backup path for a fast reroute process to be utilized in response to a network event invalidating a primary path to a destination node, where the method reduces computational requirements of the network element by reducing a number of paths to be evaluated without affecting selection of the backup path, the method comprising the steps of:
selecting a neighbor node P of a source node S to calculate a shortest path tree (SPT) for the neighbor node P for use in identifying backup paths for source node S;
calculating the SPT for the neighbor node P, pruning paths from the SPT that traverse source node S or that fail an LFA condition;
selecting the neighbor node P for the next hop of the backup path for a destination node X where the SPT of the neighbor node P provides an LFA path from the source node S to the destination node X.

2. The method of claim 1, wherein the LFA condition is optimal distance (P, X)<optimal distance (P, S)+optimal distance (S, X), measured in terms of the aggregated link cost along the LFA path.

3. The method of claim 1, wherein calculating the SPT further comprises the steps of:
selecting a next destination node X to identify a shortest path from P; and
pruning possible paths from P to X that traverse source node S.

4. The method of claim 1, wherein calculating the SPT further comprises the steps of:
selecting a next destination node X to identify a shortest path from P; and
pruning possible paths from P to X that fail the LFA condition.

5. The method of claim 1, further comprising the step of:
updating a forwarding information base with next hop of selected neighbor node P for destination node X.

6. The method of claim 1, wherein the neighbor node P is a remote node connected by a tunnel from the source node S to provide a neighbor relationship between source node S and neighbor node P, where the remote backup LFA path includes a first segment defined by the tunnel and a second segment being a shortest path from neighbor node P to the destination node D.

7. The method of claim 1, wherein selection of the LFA path is conditioned based on preferences for nodes traversed by the LFA path, where the LFA path provides protection in case of failure of nodes traversed by the primary path can be preferred or administrative preference or disinclination of specific nodes can be used in the path selection.

8. The method of claim 1, wherein selection of the LFA path is conditioned based on preferences for links traversed by the LFA path, where the LFA path provides protection in case of failure of links traversed by the primary path can be preferred, or administrative preference or disinclination of specific links can be used in the path selection.

9. A network element configured to implement a method to determine a next hop of a backup path for a fast reroute process to be utilized in response to a network event invalidating a primary path to a destination node, where the method reduces computational requirements of the network element by reducing a number of loop paths to be evaluated without affecting selection of the backup path, the network element comprising:
at least one forwarding element to forward data traffic along a primary path until the network event and to forward the data traffic along the backup LFA path after the network event;
a route processor coupled to the at least one forwarding element, the route processor configured to execute a primary path calculation module and a backup path calculation module, the backup path calculation module configured to select a neighbor node P of a source node S to calculate a shortest path tree (SPT) for the neighbor node P for use in identifying backup paths for source node S, to calculate the SPT for the neighbor node P, pruning paths from the SPT that traverse source node S or that fail an LFA condition, and to select the neighbor node P for the next hop of the backup path for a destination node X where the SPT of the neighbor node P includes an LFA path from the source node S to the destination node X.

10. The network element of claim 9, wherein the LFA condition is optimal distance (P, X)<optimal distance (P, S)+optimal distance (S, X), measured in terms of the aggregated link cost along the LFA path.

11. The network element of claim 9, wherein the backup path calculation module is further configured to calculate the SPT further by selecting a next destination node X to identify a shortest path from P, and pruning possible paths from P to X that traverse source node S.

12. The network element of claim 9, wherein the backup path calculation module is further configured to calculate the SPT further by selecting a next destination node X to identify a shortest path from P, and pruning possible paths from P to X that fail the LFA condition.

13. The network element of claim 9, wherein the backup path calculation module is further configured to update a forwarding information base with next hop of selected neighbor node P for destination node X.

14. The network element of claim 9, wherein the neighbor node P is a remote node connected by a tunnel from the source node S to provide a neighbor relationship between source node S and neighbor node P, where the remote backup LFA path includes a first segment defined by the tunnel and a second segment being a shortest path from neighbor node P to the destination node D.

15. A controller of a split-architecture network configured to implement a method to determine a next hop of a backup path for a fast reroute process to be utilized in response to a network event invalidating a primary path from a network element that is a source node S to a destination node in the network, where the method reduces computational requirements of the controller by reducing a number of paths to be evaluated without affecting selection of the backup path, the controller comprising:
a flow controller to configure the network event to forward data traffic along a primary path before the network event and along the backup LFA path after the network event;
a processor coupled to flow controller, the processor configured to execute a primary path calculation module and a backup path calculation module, the backup path calculation module configured to select a neighbor node P of the source node S to calculate a shortest path tree (SPT) for the neighbor node P for use in identifying backup paths for source node S, to calculate the SPT for the neighbor node P, pruning paths from the SPT that traverse source node S or that fail an LFA condition, and to select the neighbor node P for the next hop of the backup path for a destination node X where the SPT of the neighbor node P has the least hops to the destination node X.

16. The controller of claim 15, wherein the LFA condition is optimal distance (P, X)<optimal distance (P, S)+optimal distance (S, X), measured in aggregate link cost along the paths.

17. The controller of claim 15, wherein the backup path calculation module is further configured to calculate the SPT further by selecting a next destination node X to identify a shortest path from P, and pruning possible paths from P to X that traverse source node S.

18. The controller of claim 15, wherein the backup path calculation module is further configured to calculate the SPT further by selecting a next destination node X to identify a shortest path from P, and pruning possible paths from P to X that fail the LFA condition.

19. The controller of claim 15, wherein the backup path calculation module is further configured to configure a forwarding information base with next hop of selected neighbor node P for destination node X via the flow controller.

20. The controller of claim 15, wherein the neighbor node P is a remote node connected by a tunnel from the source node S to provide a neighbor relationship between source node S and neighbor node P, where the remote backup LFA path includes a first segment defined by the tunnel and a second segment being a shortest path from neighbor node P to the destination node D.
